(19) United States
(12) Patent Application Publication
(10) Pub. No.: US 2019/0120416 A1
(43) Pub. Date: Apr. 25, 2019

(54) TUBULAR LINING WITH A MACHINE-READABLE DATA TAG COMPRISING AN INDIVIDUAL TECHNICAL SPECIFICATION FOR CURING THE TUBULAR LINING

(71) Applicant: SML VERWALTUNGS GMBH, Rohrbach (DE)

(72) Inventors: Herbert Wind, Albersweiler (DE); Christian Noll, Limburgerhof (DE)

(21) Appl. No.: 16/075,390

(22) PCT Filed: Feb. 3, 2017
(86) PCT No.: PCT/DE2017/100080

§ 371 Date: Oct. 30, 2018

(30) Foreign Application Priority Data
Feb. 4, 2016 (DE) 10 2016 102 017.6

(51) Int. Cl. F16L 55/165; F16L 11/12; G06K 19/07; G06K 19/06; B29C 63/34; B32B 1/08; B32B 27/12; B32B 27/30; B32B 27/34

(52) U.S. Cl. CPC F16L 55/1656; F16L 55/1652; F16L 11/124; G06K 19/0723; G06K 19/06037; B29C 63/34; F16L 2201/60; B32B 27/12; B32B 27/30; B32B 27/34; B32B 2597/00; B32B 2260/046; B32B 2307/7265; B32B 1/08

(57) ABSTRACT

The present invention relates to a lining tube for renovating fluid-conducting pipe systems, wherein the lining tube comprises at least one thermally and/or radiation curable layer and at least one machine-readable data tag, wherein the at least one data tag comprises at least one individual technical specification for the lining tube, which can be processed by a data processing device in order to provide parameters for a curing apparatus, in particular for controlling or regulating a curing process of the lining tube and/or a pulling device, in particular for controlling or regulating pulling in the lining tube.

The present invention relates to a lining tube with a machine-readable data tag comprising an individual technical specification for pulling in and/or curing the lining tube, and to a method for pulling in and/or curing a lining tube.

To inspect, maintain and renovate pipes, duct systems and the like, apparatuses are often inserted into the pipes to carry out the required measuring procedures and/or mechanical renovation work. In order to measure the actual state of a pipe, the apparatuses generally comprise camera systems to visualize the condition of the pipe.

If a defect or damage is detected, the relevant section of the pipe system can be replaced with new sections. However, this is generally very expensive.

Alternatively, methods for the renovation of pipe systems, e.g. channels and similar piping systems, are known in the state of the art, in which a flexible, curable layer impregnated with a curable resin can be used as a lining tube, also referred to as a liner, and inserted into the pipe system. After insertion, the lining tube is expanded, so that it fits snugly against the inner wall of the pipe system. The resin is subsequently cured.

The production of such a lining tube is described in WO 95/04646, for example. According to the known methods, unsaturated polyester resins or vinyl ester resins, which can be dissolved in styrene and/or an acrylic ester, for example, are preferred for use as curable resins. These unsaturated polyester or vinyl esters can be cured thermally (usually with the aid of peroxide catalysts) or by means of radiation, e.g. via UV light with photoinitiators, as described, for example, in EP-A 23623. So-called combination curing with a peroxide initiator used for thermal curing in combination with photoinitiators is possible as well, and has proven to be advantageous, in particular for lining tubes having large wall thicknesses. A method for such a so-called combination curing is described, for example, in EP-A 1262708.

A radiation-curing lining tube typically comprises a light-impermeable outer protective film, an inner film which is permeable to at least certain wavelength ranges of electromagnetic radiation, and a curable layer which is impregnated with a resin and disposed between the inner film and the outer film. The purpose of the outer film tube is to prevent the resin used for impregnation from leaking out of the curable layer and escaping into the environment. This requires good leak-tightness and the attachment of the outer film tube to the resin-impregnated curable layer.

A lining tube comprising an inner film tube, a fiber band impregnated with a resin as a curable layer and an outer tube, the inside of which is clad with a fiber fleece, is known from WO 00/73692 A1.

To produce it, the resin-impregnated fiber band is often wound onto the inner tube of a lining tube in a helical and overlapping manner. The outer tube is subsequently likewise wound around the resin-impregnated fiber band in a helical and overlapping manner.

To simplify production, the inner tube itself is also wound around a winding mandrel. Alternatively, WO 95/04646 for example, discloses the inflation of a prefabricated inner film tube that can then itself serve as a winding mandrel. Such a prefabricated inner film tube is produced from a film strip, the film edges of which are joined to one another by welding or adhesive bonding in order to form the inner film tube.

The lining tubes are inserted into the pipe system to be renovated prior to curing and inflated by means of a fluid, usually compressed air. To inflate the lining tube, one opening end of the lining tube is supplied with compressed air according to the state of the art and the opposite opening end of the lining tube is closed with a closing device, a so-called packer. This closing device comprises a hollow cylinder and a cover element, by means of which the hollow cylinder can be closed.

To cure the lining tube, a curing apparatus comprising a radiation source is inserted and moved through the lining tube to activate or carry out the curing of the curable layers of the lining tube using radiation energy. Complete curing of the lining tubes is crucial, i.e. a specific quantity of radiation energy must be introduced into each point of the lining tube. The quantity of radiation energy is a function of the power output of the radiation sources and the speed, with which said radiation sources are moved through the lining tube.

According to the state of the art, a variety of requirements, which are respectively based on the individual technical specifications of the lining tube, have to be observed for the placement and curing of a lining tube. During installation, care must be taken to ensure that the method being used is material-friendly (e.g. limitation of the pulling forces; prior removal of broken pieces, deposits or the like, which can cause damage).

The limitation of the pulling forces is ensured by a traction force limitation at the winch, wherein the maximum traction force is manually obtained by the user from the technical specifications of the respective lining tube. This is necessary to prevent damage to the lining tube during placement.

In order to enable sufficient curing of the curable layer of a lining tube, a sufficient quantity of activation energy has to be provided. A suitable curing apparatus must first be selected by the user, which is then moved through the lining tube manually or automatically at predetermined speeds and power outputs and, if necessary, minimum and maximum temperatures of the curable layers, to cure said lining tube.

The appropriate parameters have to be selected and observed for the curing itself, for example the approach of the curing apparatus, the speed with which it travels through the lining tube, the required curing energy, etc. Among other things, these parameters are a function of the diameter of the lining tube, the wall thickness, the material or the structure of the curable layer as well as other factors.

The disadvantage of the state of the art is that, due to the variety of different lining tubes, the correct parameters have to be selected manually by a user in each case and observed when carrying out the curing or, for automatic curing, they have to accordingly be entered properly. Errors, which prevent the lining tube from being pulled in or cured in accordance with the specifications, often occur in worksite operation, so that the pipe is not renovated properly. Improper renovation of a pipe with a lining tube leads to very high costs for another renovation.

The object of the present invention is therefore to overcome the disadvantages of the state of the art and in particular to ensure that a lining tube is pulled in and cured using the individual technical specifications of the lining tube.

This object is achieved by a lining tube for renovating fluid-conducting pipe systems, wherein the lining tube comprises at least one radiation curable layer and at least one machine-readable data tag, wherein the at least one data tag comprises at least one predetermined, non-variable, individual technical specification for the lining tube, which can be processed by a data processing device in order to provide parameters for a curing apparatus for controlling or regulating a curing process of the lining tube and/or a pulling device for controlling or regulating pulling in the lining tube prior to curing and/or prior to pulling in the lining tube.

The data tag according to the invention is in particular a Quick Response Code (QR code) tag, a Radio-Frequency Identification (RFID) tag, a Near Field Communication (NFC) tag and/or a bar code tag.

A lining tube according to the invention makes it possible for a user to not have to manually correlate the technical specifications of a lining tube and the parameters for pulling in and curing; said specifications are instead input simply by reading the data tag. This eliminates incorrect inputs that result in the improper renovation of a pipe with a lining tube. It is particularly advantageous that the at least one predetermined, non-variable, individual technical specification is already provided by the manufacturer. This specification can in particular not be changed by a user. This specification is advantageously not changed during the curing process. It can furthermore be advantageous that the data tag is not in operative connection with sensors. It can also be provided that the data tag is used exclusively to make the at least one specification available.

A further advantage of the lining tube according to the invention is that the setup time can be reduced significantly. This is due to the fact that all the required information is available with one work step. The technical specifications can be used to automatedly pull in and/or cure the lining tube or to, in particular partially manually, pull in and/or cure the lining tube, by displaying said specifications to a user on a display device along with any respective existing limit values.

It can in particular be provided that the data tag comprises at least one of the following pieces of information and/or at least one representative of the following pieces of information: curing apparatuses suitable for curing the lining tube; speed range for the movement of a curing apparatus through the lining tube; approach speed of the curing apparatus into the lining tube; power output of the curing apparatus, in particular as a function of a temperature of the curable layer of the lining tube, preferably the resin reaction temperature; at least one, in particular all, curing parameters for the lining tube and/or the maximum pulling forces, in particular for a limitation of the traction force of a traction limiting device. It can in particular be provided that, in addition to the actual parameters, the data tag comprises an additively or alternatively permissible range with upper and/or lower threshold values.

A pulling and/or curing of the lining tube in accordance with the manufacturer specifications can be made possible with the aid of these parameters. It can also be provided that the data tag contains the necessary information directly, or a representative of said information. The data tag can contain a unique identification number, for example, which can be read and matched by a data processing device, as a result of which all the information can be read from a database. However, in many cases this is possible only if the necessary database is continuously updated. This type of updating necessitates an exchange of data between the data processing device and a server, which would require an internet connection. For the present application of lining tubes on worksites, it can therefore be advantageous if the information needed to pull in and/or cure the lining tube is stored directly in the data tag, thus making network connectivity unnecessary.

Such a lining tube can in particular be a lining tube having a curable layer impregnated with a photochemically curable resin, the curing of which can in particular be activated by means of radiation energy in a wavelength range from 351 to 800 nm. It is obvious, however, that all the lining tubes known to the person skilled in the art, regardless of whether they can be cured thermally, by means of radiation or by combination curing, are included in the present invention, and a data tag according to the invention is advantageous regardless of the type of curable layer.

According to one embodiment of the invention, it can also be advantageous for a lining tube to comprise at least the following layers:
a) at least one inner film tube;
b) at least one curable layer;
c) at least one outer layer and/or outer film tube, wherein
   the data tag and/or an identification feature for the data tag is preferably disposed on the outer side of the outer layer and/or the outer film tube and/or on the inner side of the inner film tube, so that the data tag and/or the identification feature for the data tag is visible to a user.

An arrangement of the data tag on or within the two outer layers of the lining tube has proven to be advantageous; it allows a user to readily see and read said data tag with the aid of a data tag reading device. If the data tag is integrated into one of the layers of the lining tube, as is the case for an RFID tag in order to protect said data tag, for example, identifying this position of the data tag for a user by means of an identification feature has been found to be advantageous, so that it can easily be read.

The invention also provides an arrangement comprising a lining tube according to any one of the preceding claims; a curing apparatus for the lining tube; a data processing device; a control or regulating device; a data tag reading device and in particular a pulling device, wherein the control or regulating device is designed and configured to control or regulate a pulling device for pulling the lining tube into a pipe to be renovated and/or the curing apparatus for curing the curable layer of the lining tube on the basis of data of a data tag received by the data processing device by means of the data tag reading device.

The arrangement according to the invention allows a user with a data tag reading device to read all the relevant technical specifications of a lining tube using simple means. The data tag reading device can be a QR code or barcode scanner; in the simplest case it can even be the camera of a smartphone with an appropriate software application installed on the smartphone. The data tag can then be read by means of simple photographing or scanning. The same applies for NFC data tags. Alternatively, the data processing device, which is usually present at least for the metrological recording and the manual control of the curing process, can, of course, be used directly to read the data tag.

If a lining tube according to the invention is to be pulled into a pipe, a user can first read the data tag and send the technical specifications to the data processing device. In order to pull the lining tube in, the maximum traction forces can then be displayed directly to a user as a limit value and/or transmitted to a pulling device. This ensures that no excessively high traction forces can act on the lining tube when it is pulled in, thus avoiding any damage.

For a subsequent curing process, a suitable curing apparatus can be displayed to a user, in particular including the technical setup of said curing apparatus, such as in the case of a radiation curable lining tube, for example, the necessary light sources, the arrangement of the lamps, the spacing thereof from the walls of the lining tube, etc.

The actual guidance of the curing apparatus itself through the lining tube can be carried out manually, wherein the essential parameters and limit values can respectively be displayed to the user, or in a partially or fully automated manner on the basis of the technical specifications of the lining tube read from the data tag by means of the control or regulating device, which is in operative connection with the data processing device. It is obvious that the data processing device and the control or regulating device can be designed as one unit and, for example, configured as a conventional PC, which is or can be brought into operative connection with the curing apparatus.

The present invention also provides a method for curing a lining tube comprising the following steps, in particular in this order
a) provision of a lining tube, in particular a lining tube according to the invention, comprising at least one radiation curable layer and at least one machine-readable data tag, wherein the at least one data tag comprises at least one predetermined, non-variable, individual technical specification for the lining tube;
b) reading the at least one data tag by means of a data tag reading device and processing the read data in a data processing device prior to curing and/or prior to pulling in the lining tube;
c) displaying information about the individual technical specification for the lining tube on a display device and/or
d) controlling or regulating a pulling device for pulling the lining tube into a pipe to be renovated on the basis of the data of the data tag processed by the data processing device and/or
e) controlling or regulating a curing apparatus for curing the lining tube on the basis of the data of the data tag processed by the data processing device.

According to the invention, after the provision of a lining tube with a data tag comprising at least one technical specification of the lining tube, these specifications, in particular parameters related to pulling said lining tube into a pipe to be renovated and/or curing the lining tube, can be displayed to a user on a display device. According to further method steps, a partially automated or fully automated pulling or curing of the lining tube can be carried out as well, wherein the displayed parameters can also be used for manual control. It is thus possible for a manufacturer of a lining tube to provide information that cannot be changed by a user, which allows a user to identify which pulling devices, curing means, etc. have to be used to carry out a curing process before the work starts. It is also possible to fixedly predetermine the correct framework parameters for pulling or curing directly; these parameters do not have to be entered individually by the user. Sources of error are thus minimized and the renovation process is accelerated.

It can in particular be provided that, according to the method according to the invention, reading at least one of the following pieces of information and/or at least one representative of the following pieces of information is performed by means of the data tag reading device: curing apparatuses suitable for curing the lining tube; speed range for the movement of a curing apparatus through the lining tube; approach speed of the curing apparatus into the lining tube; power output of the curing apparatus, in particular as a function of a temperature of the lining tube, preferably the resin reaction temperature and/or at least one, in particular all, curing parameters for the lining tube and/or the maximum pulling forces for a limitation of the traction force of a traction limitation.

According to one embodiment of the method, it can also be provided that the following additional steps are included, in particular in this order:
f) selection of a suitable curing apparatus for curing the lining tube by a user on the basis of at least one technical specification for the lining tube and/or recommendation of a suitable curing apparatus for curing the lining tube by the data processing device on the basis of at least one technical specification; and
g) insertion of the curing apparatus into the lining tube.

The use of these steps can ensure that a suitable curing apparatus is used.

It can also be provided that the method according to one embodiment records measured values representative of the ignition times, the number of lit lamps, the start and end time of curing, the internal air pressure in the lining tube, the curing speed or the speed of the curing apparatus, the resin reaction temperature and/or the distance traveled by at least one measuring device, and processes and in particular stores said measured values in the data processing device, wherein the measured values are in particular used to regulate curing.

Recording the above measured values can allow an automated regulation of the curing to be performed. The measured values can alternatively be used to alert a user to a possible exceedance or undershooting of limit values with the aid of a display device. The measured values can also be used for a subsequent documentation of the specification-compliant curing.

It can also be provided that the QR code is generated prior to production of the lining tube on the basis of at least one individual technical specification for the lining tube to be produced.

The particular advantage of this is that, after an order is received, the data of the lining tube to be produced on the basis of the order can be stored directly in the data tag, so that said tag can be supplied to the user together with the lining tube after the production of the lining tube. The user then reads the data tag before pulling in or curing the lining tube, and the pulling device and/or the curing apparatus is controlled or regulated in accordance with the parameters stored in the data tag.

The features of the invention disclosed in the preceding description and the claims can be material to the implementation of the invention in its various embodiments both individually and in any combination.

1. Lining tube for renovating fluid-conducting pipe systems, wherein the lining tube comprises at least one radiation curable layer and at least one machine-readable data tag, wherein the at least one data tag comprises at least one predetermined, non-variable, individual technical specification for the lining tube, which can be processed by a data processing device in order to provide parameters for a curing apparatus for controlling or regulating a curing process of the lining tube and/or a pulling device for controlling or regulating pulling in the lining tube prior to curing and/or prior to pulling in the lining tube.

2. Lining tube according to claim 1, characterized in that
the machine-readable data tag is a Quick Response Code (QR code) tag, a Radio-Frequency Identification (RFID) tag, a Near Field Communication (NFC) tag, and/or a barcode tag.

3. Lining tube according to claim 1 or claim 2, characterized in that
the data tag comprises at least one of the following pieces of information and/or at least one representative of the following pieces of information: curing apparatuses suitable for curing the lining tube; speed range for the movement of a curing apparatus through the lining tube; approach speed of the curing apparatus into the lining tube; power output of the curing apparatus, in particular as a function of a temperature of the curable layer of the lining tube, preferably the resin reaction temperature; at least one, in particular all, curing parameters for the lining tube and/or the maximum pulling forces, in particular for a limitation of the traction force of a traction limiting device.

4. Lining tube according to any one of the preceding claims, characterized in that
the lining tube comprises a curable layer impregnated with a photochemically curable resin, the curing of which can in particular be activated by means of radiation energy in a wavelength range from 351 to 800 nm.

5. Lining tube according to any one of the preceding claims, characterized in that
at least the following layers are included:
a) at least one inner film tube;
b) at least one curable layer;
c) at least one outer layer and/or outer film tube, wherein the data tag and/or an identification feature for the data tag is preferably disposed on the outer side of the outer layer and/or the outer film tube and/or on the inner side of the inner film tube, so that the data tag and/or the identification feature for the data tag is visible to a user.

6. Arrangement comprising a lining tube according to any one of the preceding claims; a curing apparatus for the lining tube; a data processing device; a control or regulating device; a data tag reading device and in particular a pulling device, wherein the control or regulating device is designed and configured to control or regulate a pulling device for pulling the lining tube into a pipe to be renovated and/or the curing apparatus for curing the curable layer of the lining tube on the basis of data of a data tag received by the data processing device by means of the data tag reading device.

7. Method for curing a lining tube, comprising the following steps, in particular in this order
a) provision of a lining tube, in particular a lining tube according to any one of claims 1 to 5, comprising at least one radiation curable layer and at least one machine-readable data tag, wherein the at least one data tag comprises at least one predetermined, non-variable, individual technical specification for the lining tube;
b) reading the at least one data tag by means of a data tag reading device and processing the read data in a data processing device prior to curing and/or prior to pulling in the lining tube;
c) displaying information about the individual technical specification for the lining tube on a display device and/or
d) controlling or regulating a pulling device for pulling the lining tube into a pipe to be renovated on the basis of the data of the data tag processed by the data processing device and/or
e) controlling or regulating a curing apparatus for curing the lining tube on the basis of the data of the data tag processed by the data processing device.

8. Method according to claim 7 further comprising
reading at least one of the following pieces of information and/or at least one representative of the following pieces of information by means of the data tag reading device: curing apparatuses suitable for curing the lining tube; speed range for the movement of a curing apparatus through the lining tube; approach speed of the curing apparatus into the lining tube; power output of the curing apparatus, in particular as a function of a temperature of the lining tube, preferably the resin reaction temperature and/or at least one, in particular all, curing parameters for the lining tube and/or the maximum pulling forces for a limitation of the traction force of a traction limitation.

9. Method according to claim 7 or claim 8, further comprising the following steps, in particular according to step b) or c), in particular in this order
f) selection of a suitable curing apparatus for curing the lining tube by a user on the basis of at least one technical specification for the lining tube and/or
recommendation of a suitable curing apparatus for curing the lining tube by the data processing device on the basis of at least one technical specification; and
g) insertion of the curing apparatus into the lining tube.

10. Method according to any one of claims 7 to 9, characterized in that
measured values representative of the ignition times, the number of lit lamps, the start and end time of curing, the internal air pressure in the lining tube, the curing speed or the speed of the curing apparatus, the resin reaction temperature and/or the distance traveled by at least one measuring device are recorded and processed and in particular stored in the data processing device, wherein the measured values are in particular used to regulate curing.

11. Method according to any one of claims 7 to 10, characterized in that
the QR code is generated prior to production of the lining tube on the basis of at least one individual technical specification for the lining tube to be produced.
